(19) United States
(12) Patent Application Publication
(10) Pub. No.: US 2003/0214404 A1
(43) Pub. Date: Nov. 20, 2003

(54) Computer implemented method and system for locating a lost article

(76) Inventor: William Christopher Thomas, Tallahassee, FL (US)

Correspondence Address: William H. Hollimon, 118 N. Gadsden Street, Tallahassee, FL, 32301, US

(21) Appl. No.: 10/147,807

(22) Filed: May 20, 2002

(51) Int. Cl. G08B 1/08; G08B 23/00

(52) U.S. Cl. 340/539.32; 340/573.4; 340/572.1; 340/825.49

(57) ABSTRACT

A computer implemented method and system for reuniting lost articles with their owners. A tag containing a unique code number and displaying an internet address is affixed to the object. Via a client side connection to the internet, the article owner populates a server side database with contact information and information about the article. All such owner supplied information is associated with the unique code number. The owner may update the provided information at any time and for any reason.

A finder of a lost article proceeds to the internet address and inputs the unique code number. Information is then provided allowing for the reuniting of the article and its owner.

The present invention relates to a method and system for locating a lost article. In this invention, a tag containing a unique code and a website address is attached to the article. A finder is prompted to go to the website and enter the unique code. Once the unique code is validated, the website facilitates the transfer of information between loser and finder to enable the return of the lost article.

### BACKGROUND OF THE INVENTION

Each year, many pet owners experience the anguish of losing a faithful pet. Many times this occurs because there is no way to correctly associate a found pet with its owner. Some pet owners have utilized tags with a limited amount of information embossed on the tag. However, due to the size of pet collar tags, only limited information can be provided, and the information cannot be updated without replacing the tag. Additionally, many pet owners are reluctant to post personal information, such as addresses and unlisted phone numbers, where it is easy to obtain.

Some pet owners have had microchips implanted into their pet's subcutaneous tissue. These microchips are programmed to contain identifying information, e.g., name, address, phone number, related to the pet's owner. If the lost pet is found, the chip may be scanned by a Veterinarian and the information thereon retrieved. However, this method involves the cost and expense of multiple veterinarian visits and does not provide a way to easily update the owner information without replacing the microchip. Moreover, not all microchips are read by all scanners and, because the microchip is not readily apparent, some additional notification means is required to indicate the presence of a microchip.

Still other pet owners have attached tags to their pets that contain unique code numbers and a telephone number. Under this system, the owner of a lost pet calls a central telephone station, provides the unique code number, and instructs the central station to reveal information about the owner's identity if a finder calls the central station and inputs the unique code number. This and other telephone based services are expensive because of the need for an operator or employ computerized voice menu systems which are disfavored by many consumers.

Similarly, attempts have been made to reunite lost children, elderly or mentally incapacitated persons, or personal objects with a responsible party or owner using tags containing contact information for the responsible party or owner. Again, this system requires the replacement of tags when contact information changes, and is burdensome on the responsible party or owner.

Finally, none of these methods provides a way to visually confirm that the found article is the property or responsibility of the party to whom the method directs contact. None of these prior systems and methods are based on, or take advantage of the capabilities and functionalities of, the internet.

For the foregoing reasons, there is a need for a computer implemented method and system for locating a lost article.

### SUMMARY OF THE INVENTION

The present invention is directed to a computer implemented system and method of locating lost articles that provides a secure and easily updateable database of owner information, that does not require the replacement of article tags when owner information is updated, that facilitates the transfer of information necessary to reunite the found article with its owner, that provides a visual depiction of the article, and that utilizes the capabilities and functionality of the internet.

In accordance with one aspect of the invention, lost articles are reunited with their owners by producing a tag, suitable for attachment to a pet collar or other attachment point, bearing a unique code number and an internet address. Such a tag is affixed to the article and is preferably constructed from a weatherproof material. The owner of the article then, via a client side connection to the internet, enters identifying information about the owner and the article into a server side database. The database allows the owner to specify which information, and under what circumstances and by what method, this information may be released to a finder of a lost article. The owner also has the ability, at any time, to update or change any aspect of the information contained in the database via the client side data entry means by editing, adding, or deleting the information stored in the server side database.

A finder of a lost article is instructed by the tag attached to the pet, person, or object to proceed to the internet address listed and then to enter the unique code number displayed on the tag. Once the server side database determines that a valid unique code number (or tag number) has been entered via the client side data input means, the server side database then matches the owner information to the unique code number and displays information to effect the return of the lost pet, person, or object.

An additional advantage of this system and method is that it allows owners to include graphic material, i.e., pictorial material, as well as text, in the server side database. This allows for the owner to place a picture of the pet, person, or object in the database such that a finder can obtain visual confirmation that the found pet, person, or object belongs to the owner identified by the unique code. Because this system in based on the world wide communication network known as the internet, access to the server side database may be obtained from anywhere in the world where an internet connection may be established.

### BRIEF DESCRIPTION OF THE DRAWINGS

FIG. 1 is a flow chart depicting the steps of the preferred method.

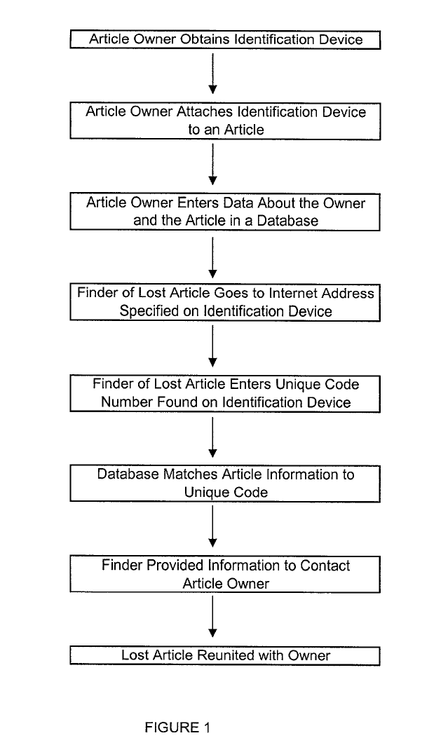

FIG. 2 is a block diagram representing a preferred embodiment of the invention.

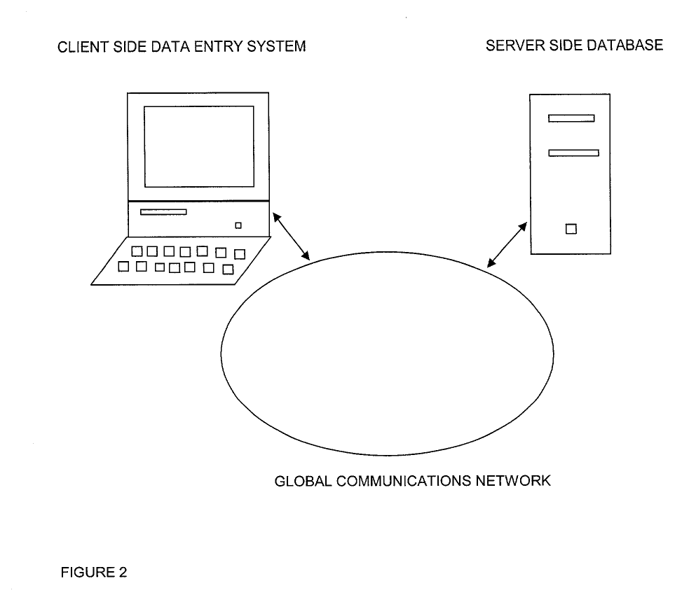

### DETAILED DESCRIPTION

The method according to the present invention for locating a lost pet, person, or object comprises the steps of providing an identification device, attaching the identification device to a pet, person, or object, including on the identification device a unique code number and an internet address, providing a database that stores information related to the pet, person, or object and its owner, providing a data input means that allows the owner to populate the database with information, providing a data input means that allows a finder of a lost pet, person, or object to enter the unique code number, and displaying information about the article and its owner to allow the return of the lost article.

The identification device provided consists of a weather proof tag suitable for attachment, for example, to a pet collar. This tag may also be attached directly to an object or worn as a bracelet or necklace by a person. This tag contains a unique code number and an internet address. Each tag's code is unique, i.e., no two tags have the same code, and is permanently displayed on the tag by printing, etching, stamping, embossing, or by some similar permanent marking method. The owner of the article utilizes a client side data input means to enter information about the article into a server side database. The client side data input means is typically a web browser connected to the internet. This web browser can be accessed by a computer, a PDA, a cell phone, or any other device that is able to establish either a wired, or wireless, connection to the internet. This information is stored and associated with the unique code number. The owner, at any time, can access the server side database and change or update the information provided. For example, if an owner's address, telephone number, e-mail address, or any other identifying information that the owner has chosen to supply changes, either temporarily or permanently, the owner simply updates the server side database to include the updated information. Identifying information about the pet, person, or object, including photographic depictions, may also be added, modified, or deleted from the server side database by the owner. The owner also has the ability to control which information is provided to a finder.

This owner supplied information is maintained in a server side database that is accessible over the internet and is associated with the unique code number. A finder of a lost article is directed by the information provided on the tag to a specific internet address. Once a finder enters the unique code via the client side data input means, typically a web browser, the finder is provided the contact information associated with the owner of the lost pet, person, or object that the owner has designated to be provided to a finder. This contact information may include the name, address, phone number, and e-mail address of the owner, or it may include only a portion of this information. The finder may also be provided a picture that provides a visual depiction of the article associated with the unique code number.

Once the finder obtains the information stored in the server side database associated with the unique code number, the finder may then contact the owner to arrange a return of the lost pet, person, or object. This contact, for example, may be by phone, mail, in person, or by email, depending upon the owner's desire.

The previously described versions of the present invention have many advantages including the use of a client side data input means and a server side database, the ability for an owner to easily update contact information, the ability to provide a pictorial representation of the lost pet, person, or object, and the use of the functionality of the internet. Because this method and system is based on the internet, it is useful and functional wherever, throughout the world, and however an internet connection may be established.

Although the present invention has been described in considerable detail with reference to certain preferred versions thereof, other versions are possible. For example the server side database could be accessed through a PDA or cell phone, via a wired or wireless connection. Therefore, the spirit and scope of the appended claims should not be limited to the description of the preferred versions contained herein.

What is claimed is:

1. A computer implemented method for locating a lost article comprising:
providing an identification device;
attaching said identification device to said article;
including on said identification device an internet address and a unique code;
under control of a client system, providing a data entry component accessible to a finder of said article for entry of said unique code and transmission of said unique code to a server system;
under control of said server system, receiving said unique code, matching said unique code with a database, and retrieving additional information previously stored in said database for said article and identified by said unique code; and
providing a means for establishing communication between said finder and a party responsible for said article.

2. The method of claim 1 wherein the article is a pet, person, or object.

3. The method of claim 1 wherein the identification device is a weatherproof tag.

4. The method of claim 1 wherein the data entry component is a web browser.

5. A computer implemented method for locating a lost article comprising:
providing an identification device;
attaching said identification device to said article;
including on said identification device an internet address and a unique code;
providing a data entry component accessible to the owner of said article for the entry of owner and article data and accessible to a finder of said article for entry of said unique code;
providing a means for matching said unique code with said owner and said article data;
providing a means for establishing communication between said finder of said article and said owner of said article.

6. The method of claim 5 wherein the article is a pet, person, or object.

7. The method of claim 5 wherein the identification device is a weatherproof tag.

8. The method of claim 5 wherein the data entry component is a web browser.
